(19) United States
(12) Patent Application Publication
(10) Pub. No.: US 2004/0181409 A1
(43) Pub. Date: Sep. 16, 2004

(54) Speech recognition using model parameters dependent on acoustic environment

(76) Inventors: Yifan Gong, Plano, TX (US); Xiaodong Cui, Los Angeles, CA (US)

Correspondence Address: TEXAS INSTRUMENTS INCORPORATED, P O BOX 655474, M/S 3999, DALLAS, TX, 75265

(21) Appl. No.: 10/386,248

(22) Filed: Mar. 11, 2003

(51) Int. Cl. G10L 15/00

(52) U.S. Cl. 704/256

(57) ABSTRACT

To make speech recognition robust in a noisy environment, variable parameter Gaussian Mixture HMM is described which extends existing HMMs by allowing HMM parameters to change as a function of a continuous variable that depends on the environment. Specifically, in one embodiment the function is a polynomial, the environment is described by signal-to-noise ratio. The use of the parameters functions improves the HMM discriminability during multi-condition training. In the recognition process, a set of HMM parameters is instantiated according to parameter functions, based on current environment. The model parameters are estimated using Expectation-Maximization algorithm for variable parameter GMHMM.

### FIELD OF INVENTION

This invention relates to speech recognition and more particularly to a speech recognition method using speech model parameters that depend on acoustic environment.

### BACKGROUND OF INVENTION

Speech recognition in different environments using Hidden Markov Models (HMMs) requires modeling speech distribution in the given environment. It has been observed quite often that the mismatched training and testing environments can lead to severe degradation in recognition performance. See article by Yifan Gong entitled “Speech Recognition in Noisy Environments A Survey” in Speech Communication, 16(3): pages 261-291,1992. In order to achieve robust speech recognition in noise, different approaches have been proposed to deal with the mismatch issue. Among these methods, people use noisy speech during the training phase which can be generalized to multi-condition training where available speech data collected in a variety of environments is used in model training. See the following references for more description.

Dautrich, B. A., Rabiner, L. R., and Martin, T. B. “On the Effect of varying Filter Bank Parameters on Isolated Word Recognition”, IEEE Transactions on Acoustic, Speech and Signal Processing, ASSP-31: 793-806, 1983.

Morii, S. T., Morii, T., and Hoshimmi, M. “Noise Robustness in Speaker Independent Speech Recognition”, International Conference on Spoken Language Processing, Pp. 1145-1148, 1990.

Furui, S. “Toward Robust Speech Recognition Under Adverse Conditions”, ESCA Workshop Proceedings of Speech Processing in Adverse Conditions, Pp. 31-41, 1992.

Vaseghi, S. V., Milner, B. P., and Humphries, J. J. “Noisy Speech Recognition Using Cepstral-Time Features and Spectral-Time Filters”, ICASSP, Pp 925-928. 1994.

Mokbel, C. and Chollet, G. “Speech Recognition in Adverse Environments: Speech Enhancement and Spectral Transformations: ICASSP, Pp. 925-928, 1991.

Lippman, R. P., Martin, E. A. and Paul, D. B. “Multi-style Training for Robust Isolated-Word Speech Recognition”, ICASSP Pp. 705-708, 1987.

Blanchet, M., Boudy, J. and Lockwood, P. “Environment Adaptation for Speech Recognition in Noise,” EUSIPCO, vol. VI, Pp 391-394, 1992.

Published Gaussian mixture hidden Markov modeling of speech uses multiple Gaussian distributions to cover the spread of the speech distribution caused by the noise. Two problems with this approach can be mentioned.

Since no noise model is incorporated and since the recognition accuracy is only optimized to the intensity characteristics of the training noise, recognition performance could be sensitive to noise level.

At the recognition time, a speech signal can only be produced in a particular environment. However, for a given noisy environment, the distribution of all conditions, as well as the ones corresponding to the given environment, are open to the search space. The variety of the noisy speech distributions decreases the model discrimination ability. Therefore, the improvement on noisy speech recognition is obtained at the cost of sacrificing the recognition rate for clean speech.

Because of the two problems, the modeling of speech events could be distracted by the inefficient use of parameters, resulting in the loss of discrimination ability.

### SUMMARY OF THE INVENTION

In accordance with one embodiment of the present invention the modeling of speech signals uses variable parameter Gaussian mixture HMM. Existing HMM is extended by allowing HMM parameters to change as function of a continuous variable that depends on the environment. At the recognition time, a set of HMMs will be instantiated corresponding to a given environment.

### DESCRIPTION OF DRAWING

FIG. 1 is a variable parameter GHMM training block diagram.

FIG. 2 is a variable parameter GMHMM recognition block diagram.

FIG. 3 is a variable parameter GMHMM regression function initialization block diagram.

FIG. 4 is a variable parameter GMHMM re-estimation block diagram.

### DETAILED DESCRIPTION OF THE PREFERRED EMBODIMENTS

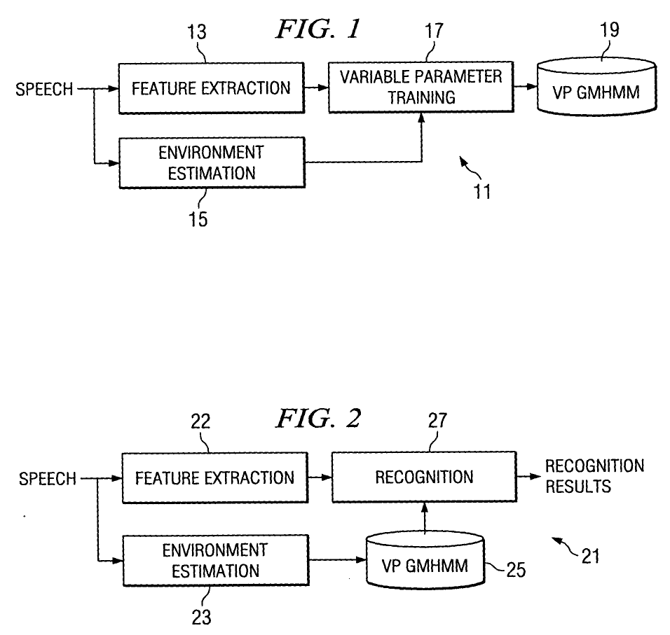

FIG. 1 is a block diagram showing the variable parameter GMHMM training module 11. The input signal is first converted to a sequence of feature vectors by the feature extraction block 13. The environment estimation block 15 estimates an environment variable that is based on the input speech signal. Using the estimated environment information, variable parameter training algorithm in block 17 generates variable parameter (VP) Gaussian Mixture Hidden Markov Model (GMHMM) from the speech feature vector sequence. This is stored is a database. 19.

FIG. 2 is a block diagram showing the variable parameter GMHMM recognition module 21. The input signal is applied to feature extraction block 22 and environment estimation block 23. During the recognition time, environment estimation block 23 estimates the environment variable of the speech to be recognized and instantiate a set of GMHMM 25 based on the variable which is used to conduct recognition process at recognition 27.

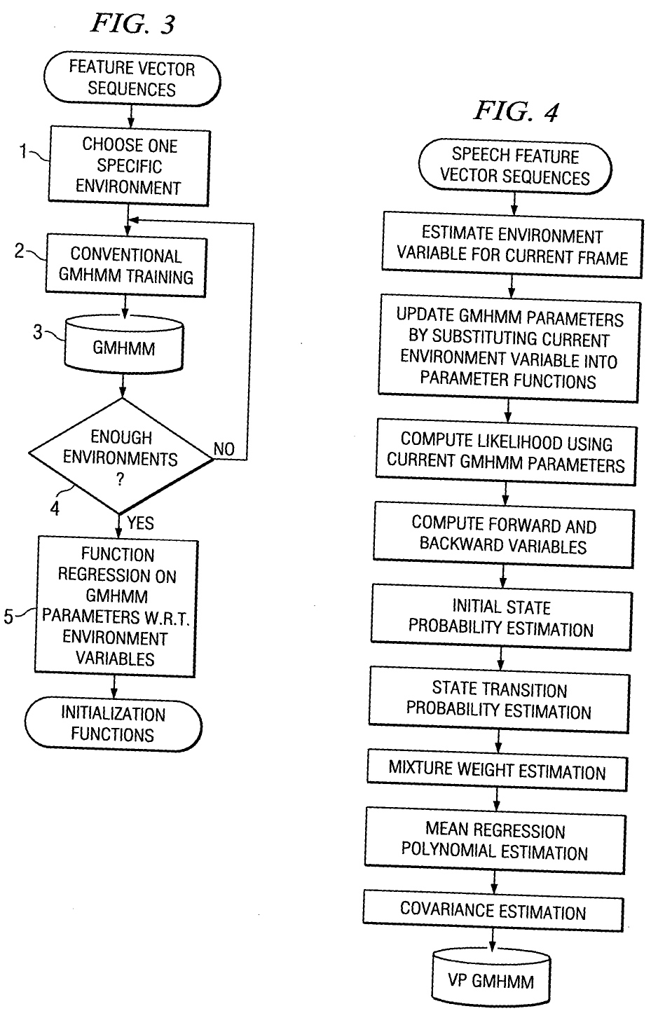

The training module algorithm of variable parameter GMHMM contains two parts, one is the initialization of GMHMM parameter functions and the other is the re-estimation procedure based on Expectation-Maximization (EM) algorithm. Referring to FIG. 3, in the function initialization step, a set of environment-specific variable values is chosen, which includes adequate cases of different environment conditions. This set of environment variable values is representative for a wide range of environments.

Particularly, signal-to-noise ratio can be adopted as a variable to model the environment. In that case, the set of values could be different signal-to-noise ratio (SNR) levels. For all the values in this set, conventional GMHMM model is trained. The resulting models under those environment variable values are regressed by the parameter functions with respect to those environment variable values. The regression functions are considered as the initialization GMHMM parameter functions for the variable parameter GMHMM. The process steps in FIG. 3 start with Step 1 of choosing a specific environment. Step 2 is performing conventional GMHMM training and storing the result in a database is step 3. These steps repeat in step 4 until enough environments have been stored. The next step 5 is performing function regression on GMFMM parameters with respect to the environment variables.

The variable parameter re-estimation procedure is maximum likelihood criterion based Expectation-Maximization (EM) algorithm which is illustrated in FIG. 4 for a special case where polynomial function is chosen to model the Gaussian mean function and SNR is chosen as the environment variable. For the input speech feature vector sequence, SNR is estimated for each frame and a specific set of GMHMM parameters is generated by substituting current SNR value into the mean vector polynomial. The likelihoods of feature vectors are computed using newly generated models which is followed by forward and backward variable calculation.

In a conventional HMM based recognizer, at the state i, the emission probability density function is a multivariate Gaussian mixture distribution which can be expressed as

$$p ( {o}_{t} \vert {s}_{t} = i ) = {\sum }_{k} {α}_{i , k} {b}_{i , k} ( {o}_{t} ) = {\sum }_{k} {α}_{i , k} N ( {o}_{t} ; {μ}_{i , k} , {\sum }_{i , k} ) \qquad ( 1 )$$

where:

oₜ is the input vector at time t, in D-dimensional feature space.

μ_{i,k} is the mean vector of the k^{th} mixture component at the state i.

Σ_{i,k} is the covariance matrix of the kₜₕ mixture component at the state i.

α_{i,k}=Pr(ξₜ=k|sₜ=i) is the a prior probability of the k^{th} mixture component at the state i.

In the VP-GMHM, the observation mean vector is modeled as a polynomial function of environment υ:

$${μ}_{ik} ( υ ) = {\sum }_{j}^{{P}_{ik}} {c}_{ikj} {υ}^{j} \qquad ( 2 )$$

where Pᵢₖ is the order of polynome for the k^{th} mixture component at the state i.

Let cᵢₖ be the vector composed of [cᵢₖ₁, cᵢₖ₂, cᵢₖⱼ, . . . ]′. The polynomial coefficients of the mean vector can be solved through linear system equation:

Aᵢₖcᵢₖ=bᵢₖ (3)

where A ᵢₖ is a (Pᵢₖ+1)×(Pᵢₖ+1) dimensional matrix:

$${A}_{ik} = [ \begin{matrix}{u}_{ik} ( 0 , 0 ) & ⋯ & {u}_{ik} ( 0 , {P}_{ik} ) \\ ⋮ & {u}_{ik} ( j , p ) & ⋮ \\ {u}_{ik} ( {P}_{ik , 0 )} & ⋯ & {u}_{ik} ( {P}_{ik , ) {P}_{ik}} )\end{matrix} ]$$

where uᵢₖ (j,p) itself is a D by D matrix:

uᵢₖ(j,p)=1ᵢₖ(vᵣ,v_{r,}j,p)

bᵢₖ is a Pᵢₖ+1 dimensional vector in D-dimensional space:

bᵢₖ=[vᵢₖ (0), . . . , vᵢₖ(j), . . . vᵢₖ(Pᵢₖ)]^{T}

where vᵢₖ(j) itself is a D dimensional vector:

vᵢₖ(j)=1ᵢₖ(v_{r,}o_{t,}^{r},j,1)

and cᵢₖ a Pᵢₖ+1 dimensional vector in D-Dimensional space:

cᵢₖ=[cᵢₖ(0), . . . , cᵢₖ(j), . . . cᵢₖ(Pᵢₖ)]^{T}

The components of the linear system equation have the form:

$${I}_{ik} ( ζ , η , α , β ) = {\sum }_{r = 1}^{R} {\sum }_{t = 1}^{{T}^{r}} p ( {s}_{t}^{r} = i , {ξ}_{t}^{r} = k \vert {O}^{r} , \overline{λ} ) \cdot {\sum }_{ik}^{- 1} \cdot {ζ}^{α} {η}^{β} ,$$

where

Aᵢₖ is composed of the powers of environment variable weighted by the count for state i and the kth Gaussian component and inverse of the covariance matrix;

bᵢₖ is composed of the product of powers of observation and environment variable weighted by the count for state i Gaussian mixture k and inverse of the covariance matrix. The covariance matrix is estimated as the ratio of expected covariance value under model parameters for current environment variable in state i and kth Gaussian and expected number of staying in state i and kth Gaussian:

$${\sum }_{ik} = \frac{\begin{matrix}{\sum }_{r = 1}^{R} {\sum }_{t = 1}^{{T}_{r}} p ( {s}_{t}^{r} = i , {ξ}_{t}^{r} = k \vert {O}^{r} , \overline{λ} ) \cdot \\ {( {o}_{t}^{r} - {\sum }_{j = 0}^{{P}_{ik}} {{c}_{ikj} ( {υ}_{r} )}^{j} ) {o}_{t}^{r} - {\sum }_{j = 0}^{{P}_{ik}} {{c}_{ikj} ( {υ}_{r} )}^{j} )}^{T}\end{matrix}}{{\sum }_{r = 1}^{R} {\sum }_{t = 1}^{{T}_{r}} p ( {s}_{t}^{r} = i , {ξ}_{t}^{r} = k \vert {O}^{r} , \overline{λ} )} \qquad ( 4 )$$

In the above equations,

R is the number of speech segments.

T^{r} is the number of vectors of the r^{th} segment.

oₜ^{r} is the t^{th} vector of segment r.

vᵣ is the environment measurement for the r^{th} segment.

In the steps for speech recognition the model parameters are permitted to change as a function of environment variables. In the training process, the environment dependent model parameters are estimated by EM algorithm. In the signal to noise case the effect of noise on speech modeling is determined and this changes is modeled as a function of signal-to-noise ratio (SNR). The function is considered as a polynomial function. All of the algorithms provide model values as a condition of that polynomial. In the recognition process, a set of HMMs is instantiated according to the given environment. For SNR case, for example, the SNR is measured and one evaluates the polynomial as a function of SNR. The particular value from the polynomial is determined and that value is used for the recognition model.

Basically, the model Gaussian mean function is not fixed as in previous HMMs cases but is a function of the signal-to-noise ratio (SNR). The method of representing a parameter as a function of environment. This method can be applied to mean vector, covariance, transition, anything.

The model parameters may be any HMM parameters such as mean, covariance, state transition probability, etc. The environment variables can be any quantities that gives some measurement of the environment, in particular it can be as signal to noise ratio, the noise power, etc. Further, rather than a scalar variable, it could be an environment variable vector. The environment variable could be based on the whole utterance, each phoneme or even each frame. The parameter functions could be any continuous function. In particular, it could be polynomial function, exponential function, etc.

The training can be in two steps of parameter function initialization and parameter re-estimation based on EM algorithm. The parameter function initialization could be any regression method on the model parameters with respect to environment variables.

In accordance with one embodiment of the present invention when using polynomials function to describe change of mean vector, initial state probability is re-estimated as expected number of times in state i at time 1, based on the model instantiated by the parameter function and corresponding environment variables; state transition probability is re-estimated as the ratio of expected number of transitions from state i to state j and expected number of those transitions from state i, based on the model instantiated by the parameter function and corresponding environment variables; mixture weight is estimated as the ratio of expected number of staying in the kth Gaussian and expected number of those transitions from state i, based on the model instantiated by the parameter function and corresponding environment variables; mean vector polynomial estimation is solved as a linear system equation with matrix component being the product of powers of two quantities weighted by the count for state i, Gaussian mixture component k and inverse of the covariance; and covariance is estimated as the ratio of expected covariance in state i and kth Gaussian mixture component and expected number of staying in state i and kth Gaussian, based on the model instantiated by the parameter function and corresponding environment variables.

The method may be carried out in specific ways other than those set forth here without departing from the spirit and essential characteristics of the invention. Therefore, the presented embodiments should be considered in all respects as illustrative and not restrictive and all modifications falling within the meaning and equivalency range of the appended claims are intended to be embraced therein.

In the claims:

1. A method of speech recognition comprising the steps of:
providing variable environmental parameter models that extend existing parameters to change as a function of an environmental variable estimated by an Expectation-Maximization algorithm and
recognizing input speech using a set of models instantiated according to a current environment.

2. The method of claim 1 wherein said model parameters are Gaussian Mixture HMM.

3. The method of claim 2 wherein said parameters are one or more of mean, covariance, or state transition probability.

4. The method of claim 1 wherein said environmental variable is a quantity that gives some measure of the environment.

5. The method of claim 4 wherein said variable is signal-to-noise ratio.

6. The method of claim 5 wherein said variable is scalar variable.

7. The method of claim 5 wherein said variable is an environmental variable vector.

8. The method of claim 4 wherein said variable is noise power.

9. The method of claim 1 wherein said environmental variable is based on a whole utterance.

10. The method of claim 1 wherein said environmental variable is based on a phone.

11. The method of claim 1 wherein said environmental variable is based on a frame.

12. The method of claim 1 wherein said parameter function is a continuous function.

13. The method of claim 12 wherein said continuous function is a polynomial.

14. The method of claim 12 wherein said continuous function is an exponential.

15. The method of claim 1 wherein said providing step includes a training process that includes the steps of parameter function initialization and parameter re-estimation based on EM algorithm.

16. The method of claim 12 wherein said continuous function is a polynomial, when
using said polynomial function to describe change of mean vector,
initial state probability is re-estimated as expected number of times in state i at time 1, based on the model instantiated by the parameter function and corresponding environment variables;
state transition probability is re-estimated as the ratio of expected number of transitions from state i to state j and expected number of those transitions from state i, based on the model instantiated by the parameter function and corresponding environment variables;
mixture weight is estimated as the ratio of expected number of staying in the kth Gaussian and expected number of those transitions from state i, based on the model instantiated by the parameter function and corresponding environment variables;
mean vector polynomial estimation is solved as a linear system equation with matrix component being the product of powers of two quantities weighted by the count for state i, Gaussian mixture component k and inverse of the covariance;
covariance is estimated as the ratio of expected covariance in state i and kth Gaussian mixture component and expected number of staying in state i and kth Gaussian, based on the model instantiated by the parameter function and corresponding environment variables.

17. A speech recognition system comprising:
variable environmental parameter models that extend existing parameters to change as a function of an environmental variable estimated by an Expectation-Maximization algorithm;
estimation means responsive to input speech environment instantiate a set of models according to a current speech environment; and
a recognizer responsive to said set of models and said input speech for recognizing the input speech.

18. The recognition system of claim 17 wherein said variable parameter models change as a function of signal-to-noise ratio and said estimation means includes measuring signal-to-noise ratio.

19. The recognition system of claim 18 wherein said estimation means evaluates a polynomial as a function of signal-to-noise ratio.

20. The recognition system of claim 17 wherein said models are Guassian mixture Hidden Markov models.

21. A method of model training comprising the steps of:
converting input speech signal into a sequence of feature vectors;
estimating an environment variable based on said input speech signal;
generating variable parameter Gaussian mixture Hidden Markov models from the speech feature vector sequence using estimated environment information.

22. A method of speech recognition comprising the steps of:
extracting the features from the input signal;
estimating an environment variable of the input speech to be recognized;
instantiating a set of Gaussian mixture Hidden Markov models based on the environment estimated; and
recognizing input speech using said set of Gaussian mixture Hidden Markov models based on the environment estimated for the speech feature vector sequence.
